(19) United States
(12) Patent Application Publication
(10) Pub. No.: US 2015/0244099 A1
(43) Pub. Date: Aug. 27, 2015

(54) Connection Module

(71) Applicant: Tyco Electronics AMP Korea Ltd, Gyungsangbuk-do (KR)

(72) Inventor: Hye Jun Lee, Seoul (KR)

(73) Assignee: Tyco Electronics AMP Korea Ltd, Gyungsangbuk-do (KR)

(21) Appl. No.: 14/711,868

(22) Filed: May 14, 2015

Related U.S. Application Data
(63) Continuation of application No. PCT/KR2013/008499, filed on Sep. 24, 2013.

(30) Foreign Application Priority Data
Nov. 14, 2012 (KR) 10-2012-0129009
Jan. 8, 2013 (KR) 10-2013-0002007

(51) Int. Cl. H01R 13/508; H01R 13/52; H01R 24/60

(52) U.S. Cl. CPC H01R 13/508; H01R 24/60; H01R 13/5202; H01R 2107/00

(57) ABSTRACT

A connection module is provided and includes an inner housing, an outer housing, a plurality of second connection terminals, a shell, a first sealing member, and a second sealing member. The inner housing includes a plurality of first connection terminals. The outer housing receives the inner housing and is coupled thereto. The plurality of second connection terminals is disposed at an end portion on one side of the outer housing. The shell receives the outer housing and includes an input and output device coupling end. The first sealing member is positioned between the inner housing and the outer housing, and the second sealing member positioned between the outer housing and the shell.

### CROSS-REFERENCE TO RELATED APPLICATIONS

This application is a continuation of PCT International Application No. PCT/KR2013/008499 filed Sep. 24, 2013, which claims priority under 35 U.S.C. §119 to Korean Patent No. 10-2012-0129009 filed Nov.14, 2012 and Korean Patent No. 10-2013-002007 filed Jan. 8, 2013.

### FIELD OF THE INVENTION

The invention relate to a connection module and, more particularly, to a connection module for a mobile communication terminal.

### BACKGROUND

A general mobile communication terminal was initially used as a simple calling device. However, with the development of technologies and the application of various contents, the mobile communication terminal has evolved for various purposes. In addition to a calling function, the mobile communication terminal also adopts various additional functions, for example, a storage medium function to enable storage of personal information or credit payment processing, a moving picture experts group (MPEG) audio layer-3 (MP3) function, a camera function, a game function, a moving picture medium function, and a video calling function.

The mobile communication terminal may include various types of connection modules corresponding to ports required due to such various additional functions. The mobile communication terminal may include a universal serial bus (USB) port configured to enable an access of an input/output (I/O) device to interface a signal of a television (TV), a remote controller, an earphone, and a USB carried by a user and to be frequently connected to the mobile communication terminal as necessary, and a connection module corresponding to the I/O device, among a number of such connection modules.

However, a known connection module configured to connect a USB port and an I/O device to a mobile communication terminal may separately include a USB port connection module and an I/O device connection module in the mobile communication terminal. Thus, against the trend of miniaturizing a mobile communication terminal, the known connection module has issues of a restricted installation space and unsuitability.

Meanwhile, any connection module for a mobile communication terminal may require a waterproof function due to environment factors. However, the known connection module for a mobile communication terminal has a poor waterproof efficiency. In addition, due to restricted installation space and size, waterproofing the known connection module for the module communication terminal or providing a waterproof member thereto may be difficult.

### SUMMARY

According to an aspect of the present invention, there is provided a connection module. The connection module includes an inner housing, an outer housing, a plurality of second connection terminals, a shell, a first sealing member, and a second sealing member. The inner housing includes a plurality of first connection terminals. The outer housing receives the inner housing and is coupled thereto. The plurality of second connection terminals is disposed at an end portion on one side of the outer housing. The shell receives the outer housing and includes an input and output device coupling end. The first sealing member is positioned between the inner housing and the outer housing, and the second sealing member positioned between the outer housing and the shell.

### BRIEF DESCRIPTION OF THE DRAWINGS

In the following, embodiments shown in connection with the drawings will be described in details, and the forgoing and other features of the invention will become more apparent; and identical or similar components will be denoted with identical or similar reference numerals throughout the drawings, in which:

FIG. 1 is an exploded perspective view of a connection module according to the invention;

FIG. 2 is a perspective view of the connection module of FIG. 1;

FIG. 3 is a cross-sectional view of the connection module of FIG. 2, along line A-A;

FIG. 4 is a perspective view of the connection module of FIG. 2 being connected to an input and output device; and

FIG. 5 is a cross-sectional view of the connection module of FIG. 4, along line B-B.

### DETAILED DESCRIPTION OF THE EMBODIMENT(S)

Hereinafter, embodiments of the present invention will be described in detail with reference to the accompanying drawings. However, the present invention is not limited to the embodiments described herein. When it is determined detailed description related to a known function or configuration which may render the purpose of the present invention unnecessarily ambiguous in describing the present invention, the detailed description will be omitted here.

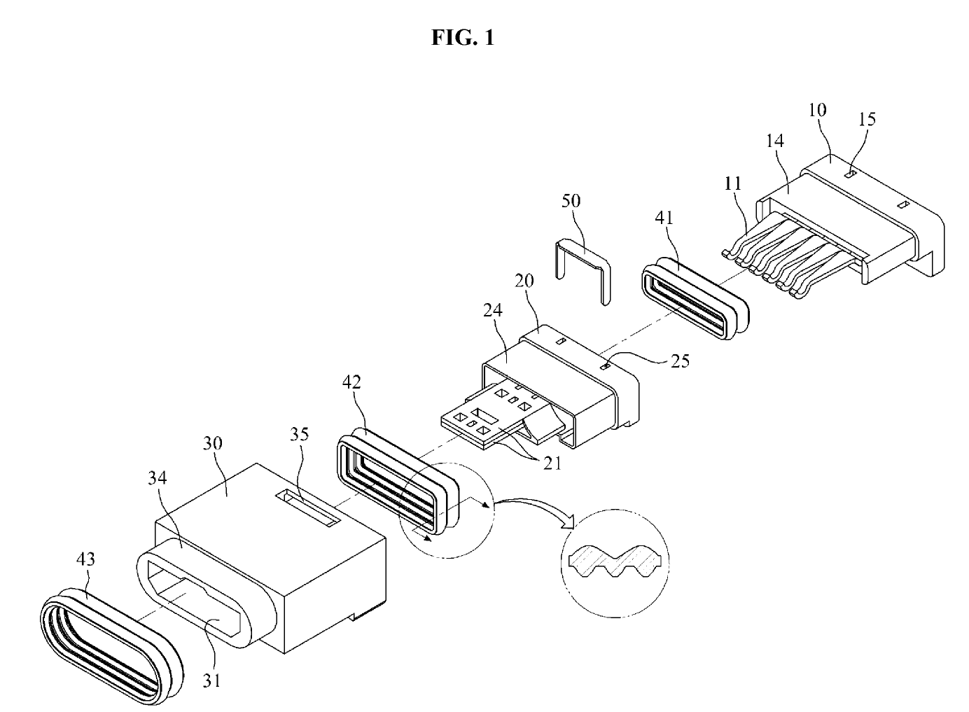

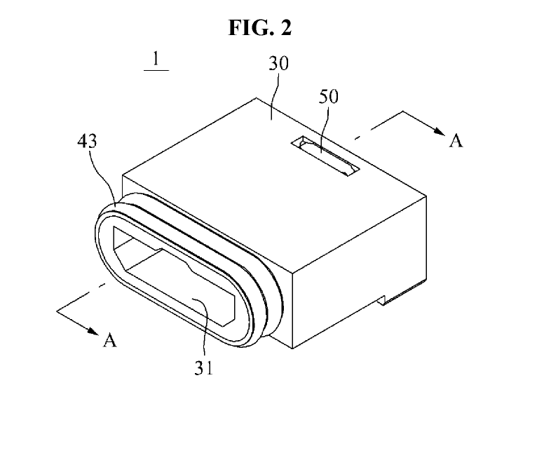

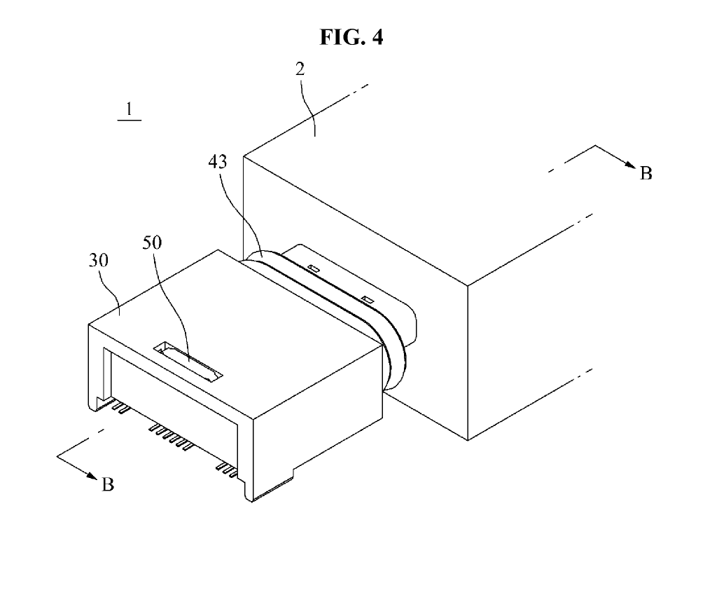

Now with reference to FIGS. 1 through 5, a connection module 1 according to an embodiment of the invention will be described in detail. The connection module 1 includes an inner housing, an outer housing 20, and a shell 30.

The inner housing 10 includes a plurality of first connection terminals 11 for electrical connection with an input and output device. The plurality of first connection terminals 11 are configured to externally extend by a predetermined length from an end portion on one side of the inner housing 10. When the inner housing 10 is coupled to the outer housing 20, the inner housing 10 may be exposed on an outer side of the outer housing 20. The first connection terminals 11 may be coupled to the inner housing 10 using an insert molding process to form the inner housing 10.

The inner housing 10 is inserted and coupled to the outer housing 20. A first sealing member 41 may be inserted to enable a space between the inner housing 10 and the outer housing 20 so as to be watertight. For example, the inner housing 10 includes a sealing member coupler 14 on which the first sealing member 41 is disposed. Here, the first sealing member 41 may be provided in a shape of a ring having a predetermined width to improve a watertight effect between the inner housing 10 and the outer housing 20. Further, the first sealing member 41 includes a single groove or a plurality of grooves along a circumference of the first sealing member 41 to increase an area of a surface to be disposed on a coupling surface of the inner housing 10 and the outer housing 20. The single groove or the plurality of grooves may be provided on a surface and an inner surface of the first sealing member 41.

The first sealing member 41 may be formed using a predetermined heat resistant material to prevent the first sealing member 41 from being damaged by heat generated when manufacturing the connection module 1 or heat generated when disposing the connection module 1 on a printed circuit board (PCB). For example, the first sealing member 41 may be formed using a material such as silicone or heat resistant rubber.

The outer housing 20 may be provided to enable the inner housing 10 to be inserted and coupled thereto, and the entire inner housing 10 may be inserted into an inner portion of the outer housing 20. A first connection terminal housing 21 into which the plurality of first connection terminals 11 is inserted may be provided at an end portion on one side of the outer housing 20. A plurality of second connection terminals 22 may be provided in the first connection terminal housing 21 of the outer housing 20 to be exposed on an outer side of the first connection terminal housing 21.

The first connection terminal housing 21 is a portion to be connected to an external input and output device 2. The first connection terminal housing 21 may receive and support the first connection terminals 11, and also electrically connect the input and output device 2 to the first connection terminals 11 and the second connection terminals 22. Here, the second connection terminals 22 may be coupled to the first connection terminal housing 21 using an insert molding process, and the first connection terminals 11 may be inserted and fastened to an internal portion of the first connection terminal housing 21.

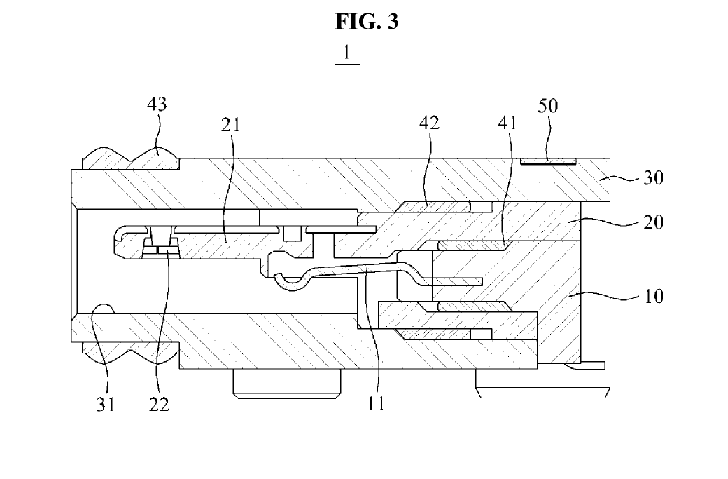

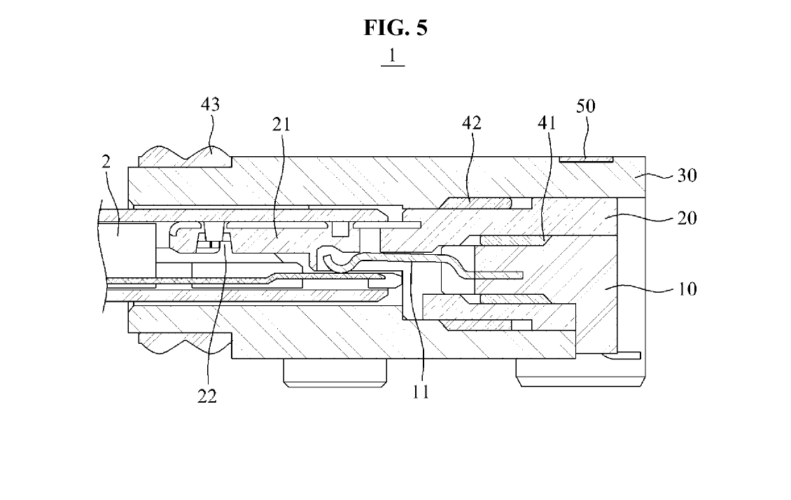

The second connection terminals 22 may be disposed at a predetermined position in a lower portion of the first connection terminal housing 21. When the inner housing 10 is inserted into the outer housing 20, the first connection terminals 11 may be coupled to the second connection terminals 22 at the predetermined position. For example, as shown in FIG. 3, the first connection terminals 11 and the second connection terminals 22 may be disposed vertically relative to each other. In detail, when the inner housing 10 is inserted into the outer housing 20, the first connection terminals 11 disposed at a front portion of the inner housing 10 may penetrate through the outer housing 20 to be positioned in an internal portion or a lower portion of the first connection terminal housing 21. Further, when the inner housing 10 is completely coupled to the outer housing 20, the first connection terminals 11 may be provided to have shorter lengths that prevent fore-end portions of the first connection terminals 11 from protruding more than the second connection terminals 22 and the first connection terminal housing 21. In addition, the second connection terminals 22 may be disposed to be selectively in contact with one side of the first connection terminal housing 21. However, the second connection terminals 22 may not be electrically in direct contact with the first connection terminals 11 by the first connection terminal housing 21. As shown in FIG. 5, when the input and output device 2 is inserted into the connection module 1, the first connection terminals 11 may be electrically in contact with the input and output device 2. Further, the first connection terminals 11 may be disposed in spaces among the second connection terminals 22. In this example, by disposing the first connection terminals 11 between the second connection terminals 22, when electrically in contact with the input and output device 2, an occurrence of interference between the second connection terminals 22 and the first connection terminals 11 may be prevented, and the connection module 1 may have a relatively low height.

As shown, the outer housing 20 is inserted and coupled to the shell 30. A second sealing member 42 may be provided on a surface on which the outer housing 20 is coupled to the shell 30 to enable a space between the outer housing 20 and the shell 30 to be watertight. A sealing member coupler 24 on which the second sealing member 42 is disposed may be provided on a portion of the outer housing 20 to be coupled to the shell 30. Here, similar to the first sealing member 41, the second sealing member 42 may be provided in a shape of a ring having a predetermined width to improve a watertight effect between the outer housing 20 and the shell 30. Further, the second sealing member 42 may include a single groove or a plurality of grooves along a circumference of the second sealing member 42 to increase an area of a surface to be disposed on a coupling surface of the outer housing 20 and the shell 30. The single groove or the plurality of grooves may be provided on a surface and an inner surface of the second sealing member 42.

Similarly, the second sealing member 42 may also be formed using a predetermined heat resistant material to prevent the second sealing member 42 from being damaged by heat generated when manufacturing the connection module 1 or heat generated when disposing the connection module 1 on a PCB. For example, the first sealing member 41 may be formed using a material such as silicone or heat resistant rubber.

The inner housing 10 and the outer housing 20 may be formed using an insulating material. Further, the inner housing 10 and the outer housing 20 may be provided using insert injection molding to improve a watertight effect and convenience of manufacturing.

The shell 30 is provided such that the inner housing 10 and the outer housing 20 are to be inserted and disposed therein, while also being coupled to each other, and form the entire exterior of the connection module 1.

The outer housing 20 in which the inner housing 10 is disposed may be disposed at one end portion of the shell 30, and an input and output device coupling end 31 may be provided at another end portion of the shell 30 so that the input and output device 2 may be inserted therein. Here, as shown in FIG. 3, when the inner housing 10 and the outer housing 20 are disposed in the shell 30, the first connection terminals 11 of the inner housing 10 and the second connection terminals 22 of the outer housing 20 may be disposed in an internal portion of the input and output device coupling end 31 of the shell 30. As shown in FIG. 5, when the first connection terminals 11 are connected to the input and output device 2, the second connection terminals 22 and the first connection terminals 11 may be electrically connected to a terminal of the input and output device 2 in the internal portion of the input and output device coupling end 31.

A third sealing member 43 may be provided on an outer side of the input and output device coupling end 31 of the shell 30 to enable the shell 30 to be watertight. Here, the third sealing member 43 may be a structure for a watertight effect of a portion on which the shell 30 is coupled to a structure of a mobile communication terminal. In detail, the third sealing member 43 may be provided to touch an inner side of a housing of the mobile communication terminal, thereby preventing an inflow of moisture or a foreign material from outside through the coupling portion. For example, the third sealing member 43 may be provided in a shape of an 0-ring to be inserted on an outer side of the input and output device coupling end 31. Further, the third sealing member 43 may include a plurality of grooves or an uneven surface on an outer surface and/or an inner surface. However, the shape of the third sealing member 43 is not limited to the drawings, and may substantially vary based on a shape or a structure of the mobile communication terminal to be coupled to.

Further, the shell 30 may be manufactured using die casting to improve a watertight performance.

Similar to the first sealing member 41 and the second sealing member 42, the third sealing member 43 may be provided in a shape of a ring having a predetermined width to improve a watertight effect, and may include a single groove or a plurality of grooves along a circumference of the third sealing member 43 to increase an area of coupling with the shell 30. The single groove or the plurality of grooves may be provided on a surface and an inner surface of the third sealing member 43.

Further, similar to the first sealing member 41 and the second sealing member 42, the third sealing member 43 may also be formed using a material having a heat resistant property at a predetermined temperature, for example, a material such as silicone or heat resistant rubber.

The connection module 1 may include a coupling device to fix a coupling state of the inner housing 10, the outer housing 20, and the shell 30. For example, as shown in FIG. 1, the coupling device may be a clip 50 configured to penetrate through the inner housing 10, the outer housing 20, and the shell 30 and be coupled to the inner housing 10, the outer housing 20, and the shell 30. In an exemplary embodiment, the clip 50 may be provided in a shape of “U” having a predetermined length, and clip couplers 15, 25, and 35 into which the clip 50 is to be inserted may be provided in the inner housing 10, the outer housing 20, and the shell 30, respectively. In this example, positions of the clip couplers 15, 25, and 35 may match when the inner housing 10, the outer housing 20, and the shell 30 are coupled to one another. Thus, when the clip 50 is inserted into the clip couplers 15, 25, and 35 while the inner housing 10, the outer housing 20, and the shell 30 are being coupled to one another, the inner housing 10, the outer housing 20, and the shell 30 may be fastened together.

However, the invention is not limited to the drawings. The coupling device may include various devices other than the aforementioned clip 50. For example, a set of a projection and a groove to be engaged with and coupled to each other may be provided on a surface on which the inner housing 10, the outer housing 20, and the shell 30 are coupled to each other. When the inner housing 10 is inserted into the outer housing 20, the projection provided on the coupling surface may be inserted into the groove and the inner housing 10 and the outer housing 20 may be fastened and coupled to each other. When the outer housing 20 is inserted into the shell 30, the projection provided on the corresponding coupling surface may be inserted into the groove and the outer housing 20 and the shell 30 may be fastened and coupled to each other. In addition, similar to the set of the projection and the groove, the coupling device may be a set of a hook and a hole provided on the coupling surface of the inner housing 10, the outer housing 20, and the shell 30 to be engaged with and coupled to each other. The coupling device may substantially vary to any device capable of fastening the inner housing 10, the outer housing 20, and the shell 30 together.

According to the embodiments, the connection module 1 includes the first sealing member 41, the second sealing member 42, and the third sealing member 43 in the inner housing 10, the outer housing 20, and the shell 30, respectively, to improve a watertight effect of the connection module 1. Further, the inner housing 10, the outer housing 20, and the shell 30 may also be provided in a watertight structure and thus, the watertight effect of the connection module 1 may effectively improve.

In addition, the inner housing 10, the outer housing 20, and the shell 30 may be provided separately and thus, the connection module 1 may be easily manufactured at a low cost. The provided inner housing 10, the outer housing 20, and the shell 30 may be separately inserted and disposed and thus, the connection module 1 may be easily assembled.

A number of embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A connection module comprising:
an inner housing having a plurality of first connection terminals;
an outer housing receiving the inner housing;
a plurality of second connection terminals disposed at an end portion on one side of the outer housing;
a shell receiving the outer housing and having an input and output device coupling end;
a first sealing member positioned between the inner housing and the outer housing; and
a second sealing member positioned between the outer housing and the shell.

2. The connection module of claim 1, further comprising a first connection terminal housing disposed at the end portion of the outer housing and receiving first connection terminals.

3. The connection module of claim 1, further comprising a third sealing member disposed on the input and output device coupling end.

4. The connection module of claim 1, wherein the shell is a watertight structure.

5. The connection module of claim 4, wherein the shell is formed using die casting.

6. The connection module of claim 1, further comprising a coupling device securing the inner housing, the outer housing, and the shell together.

7. The connection module of claim 6, wherein the coupling device is a clip penetrating through the shell.

8. The connection module of claim 7, wherein the clip couples with the inner housing and the outer housing.

9. The connection module of claim 1, wherein the plurality of first connection terminals pass through the outer housing.

10. The connection module of claim 2, wherein the plurality of second connection terminals are disposed on a lower portion of the first connection terminal housing.

11. The connection module of claim 1, wherein the plurality of second connection terminals and the plurality of first connection terminals are disposed vertically relative to each other.

12. The connection module of claim 11, wherein the plurality of first connection terminals are disposed between the plurality of second connection terminals.

13. The connection module of claim 1, wherein the plurality of first connection terminals are disposed below the plurality of second connection terminals.
